(19) United States
(12) Patent Application Publication
(10) Pub. No.: US 2014/0139996 A1
(43) Pub. Date: May 22, 2014

(54) VIBRATION-ABSORBING MODULE AND CASE STRUCTURE THEREOF

(71) Applicants: INVENTEC (PUDONG) TECHNOLOGY CORPORATION, Shanghai (CN); INVENTEC CORPORATION, Taipei City (TW)

(72) Inventors: Chung-Chien Wu, Taipei City (TW); Hung-Jung Hsia, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/802,071

(22) Filed: Mar. 13, 2013

(30) Foreign Application Priority Data
Nov. 20, 2012 (CN) 201210472833.9

(51) Int. Cl. G11B 33/08

(52) U.S. Cl. CPC G11B 33/08
USPC 361/679.34; 181/202

(57) ABSTRACT

A vibration-absorbing module comprises a case structure and an electronic device. The case structure comprises a bottom plate, two lateral walls and a plurality of vibration absorbing elements. The two lateral walls are disposed on and perpendicular to the bottom plate. The vibration absorbing elements are pivotally disposed on the two lateral walls respectively. The distance between opposing pairs of vibration absorbing elements disposed on the two opposite lateral walls is smaller than the distance between the two lateral walls. The electronic device is detachably disposed between the two lateral walls, and the vibration absorbing elements are in contact with two opposite sides of the electronic device.

This non-provisional application claims priority under 35 U.S.C. §119(a) on Patent Application No(s). 201210472833.9 filed in China, P.R.C. on Nov. 20, 2012, the entire contents of which are hereby incorporated by reference.

### BACKGROUND OF THE INVENTION

1. Technical Field of the Invention

The disclosure relates to a vibration-absorbing module, more particularly to a vibration-absorbing module and its case structure for protecting hard disks.

2. Description of the Related Art

In recent years, the rapid development of information and computer industries has enabled computers to become a part of everyday life. In addition to being a medium for storing and reading data in computer system, hard disks are also used for starting an operating system. Generally speaking, when data is read by a hard disk, a read-write head of the hard disk is moved to the data storage area for retrieving data. However, when vibration occurs during the process of reading data by the read-write head, the read-write head may get damaged or the hard disk may get damaged by the impact of the read-write head on the data storage area, reducing the reading efficiency of the hard disk. Therefore, vibration-absorbing elements are usually disposed around the hard disk in order to protect the hard disk from the influence of surrounding vibration Therefore.

Frequently, a soft pad is affixed between the hard disk and the case or chassis carrying the hard disk. The pad is thick enough to fill the gap between the hard disk and the case. This protects the hard disk from impacts to the case in a high-vibration environment. However, the soft pad creates frictional resistance between the hard disk and the case, which is unfavorable when attempting to pull out the hard disk. Such attempts may cause scratches on the hard disk or the case.

### SUMMARY OF THE INVENTION

A vibration-absorbing module comprises a case structure and an electronic device. The case structure comprises a bottom plate, two lateral walls and a plurality of vibration absorbing elements. The two lateral walls are disposed in parallel with each other at a distance from each other. The vibration absorbing elements are pivotally disposed on the two lateral walls. Also, the distance between vibration absorbing elements disposed opposite each other on the two opposite lateral walls is smaller than the distance between the two lateral walls. The electronic device is detachably disposed between the two lateral walls. The vibration absorbing elements are in contact with two opposite sides of the electronic device.

Characterized another way, a case for mounting a hard drive comprises a bottom plate, vertical walls perpendicular to the bottom plate, and a plurality of vibration-absorbing wheels. The vibration-absorbing wheels are pivotally mounted in the vertical walls. Each vibration-attenuating wheel has an axis of rotation perpendicular to the bottom plate. Moreover, each vibration-attenuating wheel comprises a vibration absorbing body mounted on an axial pivot member that extends all the way through, and extends upwardly and downwardly from, the wheel. Wheel mounting openings are formed in the vertical walls for pivotally mounting the vibration-absorbing wheels. The wheel mounting openings comprise holes formed in tabs that extend upwardly and downwardly from respective bottom and top sides of the wheel mounting openings and bend perpendicularly from the wall. Channels formed in one of each opposing pair of tabs enable an axial pivot member to be snapped into a hole connected to the channel.

### BRIEF DESCRIPTION OF THE DRAWINGS

The disclosure will become more fully understood from the detailed description given herein below for illustration only, and thus does not limit the disclosure, wherein:

FIG. 1 is a perspective view of a vibration-absorbing module according to an embodiment of the disclosure;

FIG. 2A is an exploded perspective view of the vibration-absorbing module in FIG. 1;

FIG. 2B is a partial enlarged perspective view of a case structure in FIG. 2A;

FIG. 3A is a sectional view of the case structure in FIG. 1;

FIG. 3B is a sectional view of an electronic device in FIG. 3A being assembled in the case structure; and

FIG. 4 is a perspective view of a vibration absorbing element according to an embodiment of the disclosure.

### DETAILED DESCRIPTION

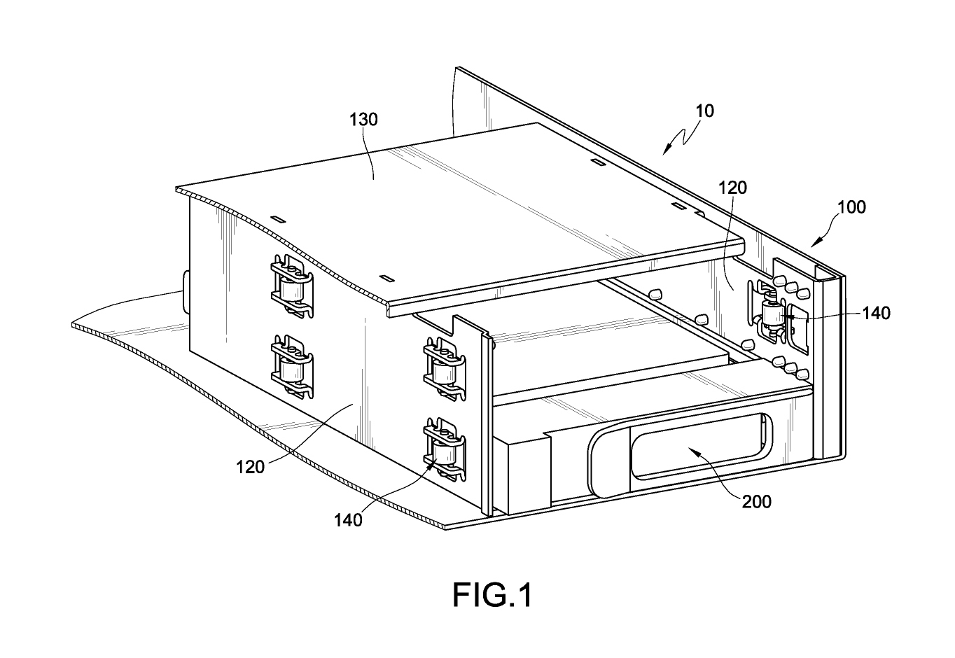

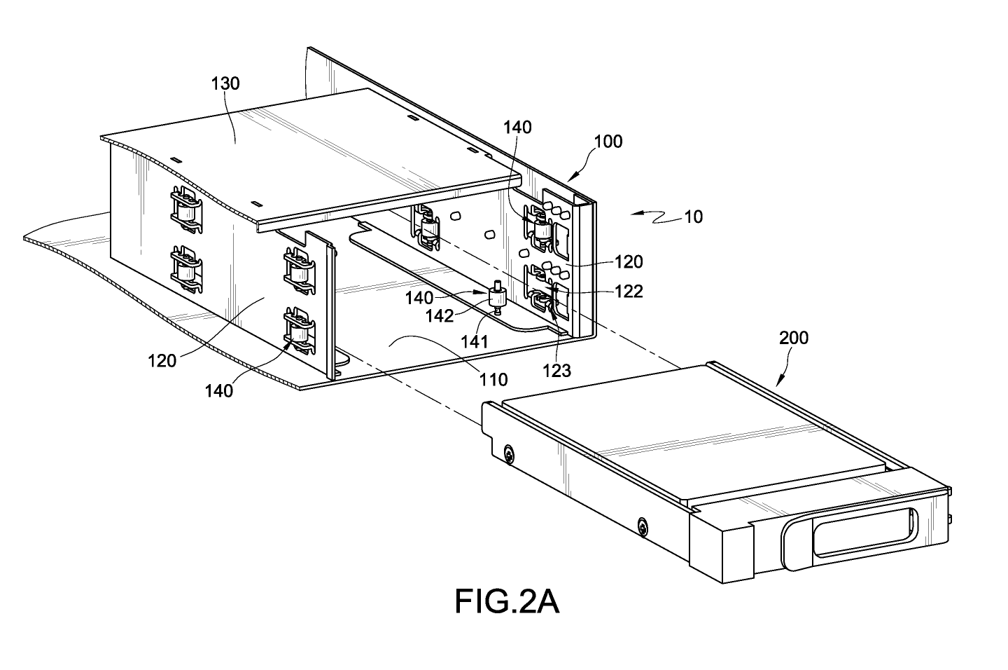

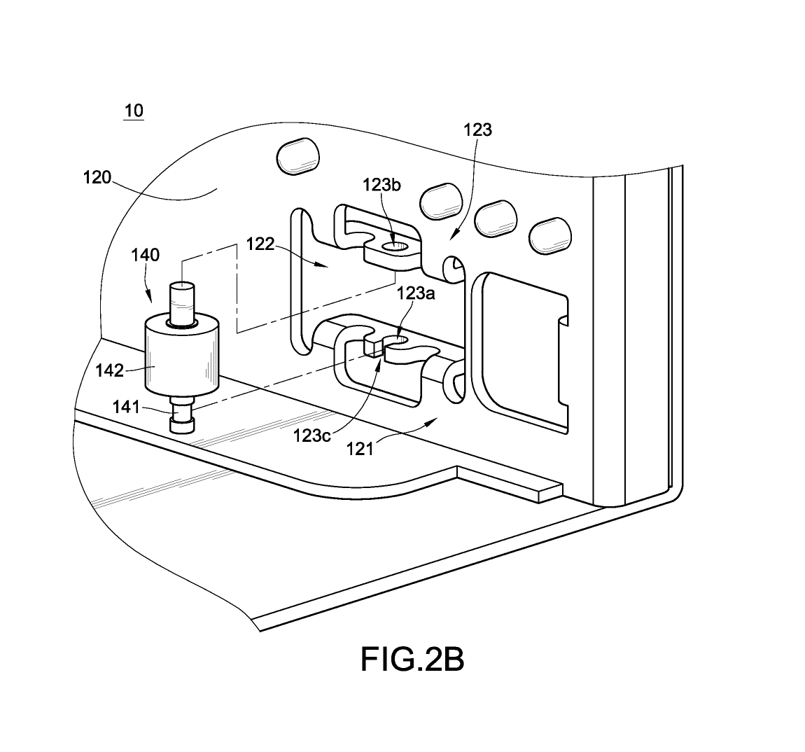

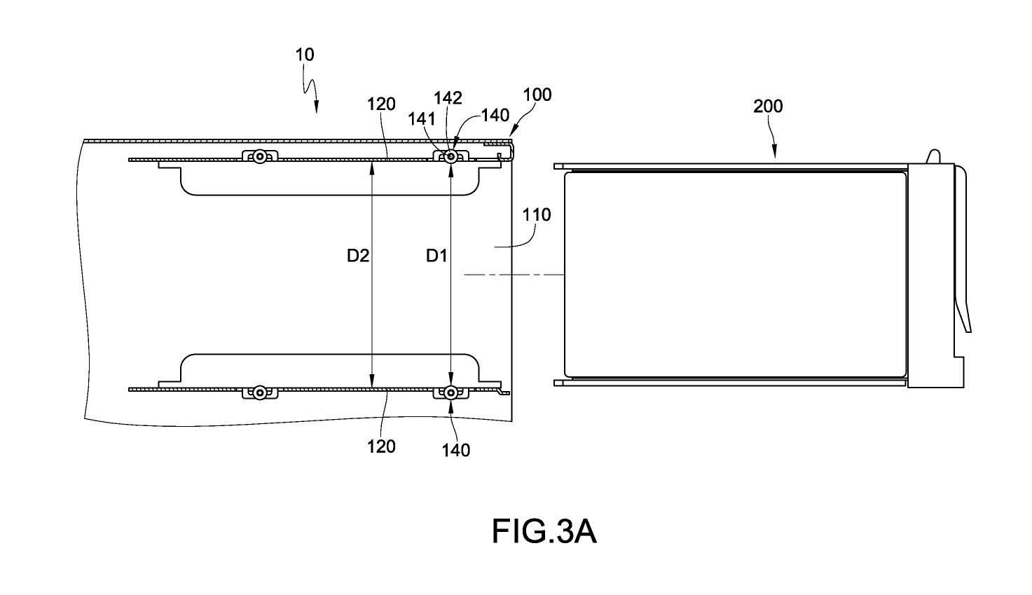

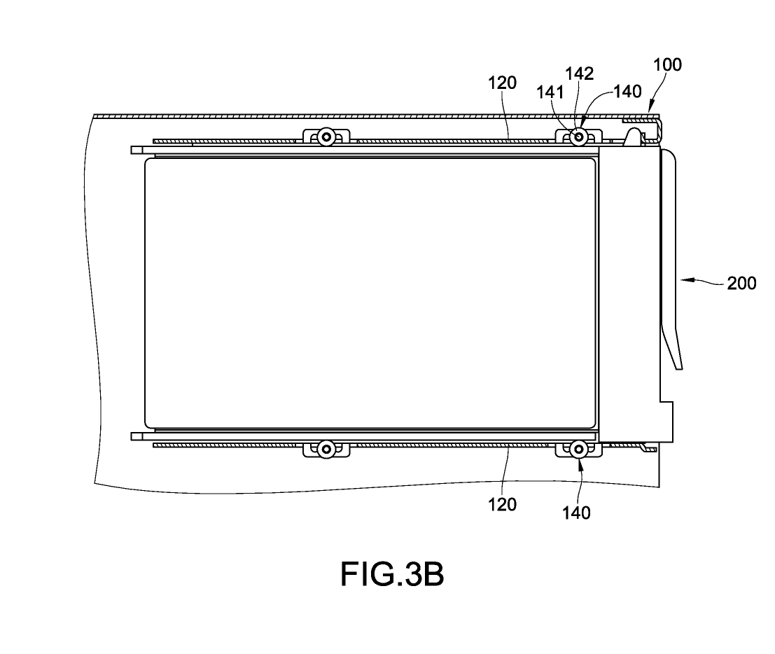

Please refer to FIGS. 1 to 3A. FIG. 1 is a perspective view of a vibration-absorbing module according to an embodiment of the disclosure. FIG. 2A is an exploded perspective view of the vibration-absorbing module in FIG. 1. FIG. 2B is a partial enlarged perspective view of a case structure in FIG. 2A. FIG. 3A is a sectional view of the case structure in FIG. 1.

A vibration-absorbing module 10 of this embodiment comprises a case structure 100 and an electronic device 200. The electronic device 200 is detachably disposed in the case structure 100. In this embodiment, the electronic device 200 is a hard disk. However, it should not be construed as a limitation to the disclosure. In other embodiments, the electronic device 200 is a device such as a compact disk drive or a compact disk burner which needs to be prevented from damage by vibration.

Specifically, the case structure 100 comprises a bottom plate 110, two lateral walls 120, a top plate 130 and a plurality of vibration absorbing elements 140. The two lateral walls 120 are parallel to each other and vertically disposed on and perpendicular to the bottom plate 110. The top plate 130 is disposed on the two lateral walls 120. A plurality of pairs of opposing vibration absorbing elements 140, such as wheels, are pivotally disposed on the two lateral walls 120. The distance D1 between two vibration absorbing elements 140 disposed opposite each other on the two opposite lateral walls 120 is smaller than the distance D2 between the two lateral walls 120 as shown in FIG. 3A.

Specifically, each of the lateral walls 120 has a surface 121 and a plurality of wheel-mounting openings 122 formed in the walls 120 and penetrating through the surface 121. Also, the walls 120 are formed with tabs that extend upwardly and downwardly from the bottom and top, respectively, of each opening 122 and bend perpendicularly and outwardly from the wall 120. A first pivotal connection hole 123a and a second pivotal connection hole 123b are disposed in the tabs, at two opposite sides of the opening 122, together forming a pivotal connection portion 123 in each hole 122. The second pivotal connection holes 123b are further away from the bottom plate 110 than the first pivotal connection holes 123a so that the vibration absorbing elements 140 are disposed perpendicularly to the bottom plate 110. Each of the pivotal connection portions 123 has an channel or slot 123c. The channel 123c is configured for communicating with the first pivotal connection hole 123a. Nonetheless, it should not be construed as a limitation to the disclosure. In other embodiments, the channel 123c is configured for communicating with the second pivotal connection hole 123b.

Each of the vibration absorbing elements 140 comprises a pivot 141 and a vibration absorbing body 142. The pivot 141 penetrates through the vibration absorbing body 142, and two opposite ends of the pivot 141 are pivotally disposed in the first pivotal connection hole 123a and the second pivotal connection hole 123b respectively. In this embodiment, one of the ends of the pivot 141 goes through the second pivotal connection hole 123b first, and then the other end squeezes into the first pivotal connection hole 123a from the channel 123c. Therefore, the pivots 141 can turn pivotally relative to the lateral walls 120 in order to reduce the frictional resistance between the electronic device 200 and the lateral walls 120 and to ease the assembly of the case structure 100 and the electronic device 200. The vibration absorbing bodies 142 of this embodiment are cylindrically shaped, and at least a part of each of the vibration absorbing bodies 142 is protrudes inwardly from the surfaces 121. Therefore, the distance D1 between opposite respective vibration absorbing elements 140 disposed on the two opposite lateral walls 120 is smaller than the distance D2 between the two lateral walls 120. Furthermore, in this embodiment, the vibration absorbing bodies 142 are made of a vibration absorbing material such as rubber or silica gel.

The electronic device 200 is detachably disposed between the two lateral walls 120, and the vibration absorbing bodies 142 are in contact with two opposite sides of the electronic device 200 respectively. Therefore, the electronic device 200 and the two lateral walls 120 are separated from each other. In other words, the lateral walls 120 and the electronic device 200 are connected through the vibration absorbing elements 140. Therefore, the damping capacity of the vibration absorbing bodies 142 is configured for reducing the vibration intensity transmitting from the case structure 100 to the electronic device 200. This improves the vibration-absorbing effect of the case structure 100. As a result, the electronic device 200 may be protected from vibrations that could otherwise reduce its performance efficiency.

The manner of assembling the case structure 100 and the electronic device 200 is described hereinafter. Please refer to FIGS. 3A and 3B. FIG. 3B is a sectional view of the electronic device in FIG. 3A being assembled in the case structure.

During the process of pushing the electronic device 200 into the case structure 100, the vibration absorbing elements 140 are configured for turning pivotally relative to the lateral walls 120. This reduces the frictional resistance between the electronic device 200 and the case structure 100 and improves the ease of assembling the electronic device 200 and the case structure 100.

When the electronic device 200 is assembled in the case structure 100, the vibration absorbing bodies 142 partially protrude inwardly from the inside surfaces 121 of the lateral walls 120 in which they are mounted. This fills a gap between the electronic device 200 and the lateral walls 120 in order to minimize impacts occurring between the electronic device 200 and the case structure 100 caused by vibration. Moreover, since the vibration absorbing bodies 142 are configured for absorbing vibration, vibrations in the case structure may be absorbed instead of transmitted to the electronic device 200 through the case structure 100. Therefore, the vibration effects of the case structure 100 can be further improved.

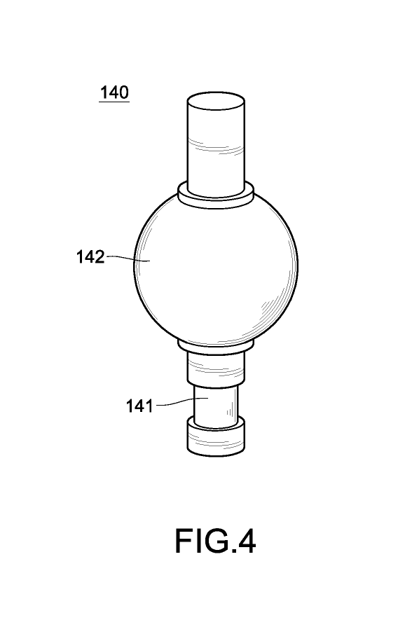

The vibration absorbing bodies 142 of this embodiment are cylindrically shaped. However, the shape of the vibration absorbing bodies 142 should not be construed as a limitation to the disclosure. Please refer to FIG. 4. FIG. 4 is a perspective view of the vibration absorbing element according to an embodiment of the disclosure. This embodiment is similar to the embodiment in FIG. 1 and therefore only the differences are described hereinafter.

The vibration absorbing element 140 of this embodiment comprises the pivot 141 and the vibration absorbing body 142. The pivot 121 penetrates through the vibration absorbing body 142. The vibration absorbing body 142 is spherically shaped and the vibration absorbing body 142 partially protrudes inwardly from the inside surfaces 121 of the lateral walls 120.

According to the vibration-absorbing module and its case structure disclosed herein, the vibration absorbing bodies protrude partially inwardly from the inside surfaces of the lateral walls in which they are mounted. This fills a gap between the electronic device and the lateral walls in order to prevent impact from occurring between the electronic device and the case structure caused by vibration. Furthermore, since the vibration absorbing elements are configured for absorbing vibration, vibrations in the case structure may be absorbed instead of transmitted to the electronic device through the case structure. Therefore, the vibration effects of the case structure may be further enhanced.

Furthermore, since the vibration absorbing elements are pivotally disposed on the lateral walls, the frictional resistance between the electronic device and the case structure is reduced through the auxiliary vibration absorbing elements when the user pushes the electronic device into the case structure or pull out the electronic device from the case structure. This enhances the convenience of assembling the electronic device and the case structure.

What is claimed is:

1. A vibration-absorbing module, comprising:
a case structure, comprising:
a bottom plate;
two lateral walls disposed in parallel with each other a distance from each other; and
a plurality of pairs of opposing vibration absorbing elements pivotally disposed on the two lateral walls, wherein a distance between opposing vibration absorbing elements is smaller than the distance between the two lateral walls; and
an electronic device detachably disposed between the two lateral walls, the vibration absorbing elements contacting two opposite sides of the electronic device.

2. The vibration-absorbing module as claimed in claim 1, wherein each of the lateral walls has a surface and a plurality of openings penetrating through the surface, each of the lateral walls provides a plurality of pivotal connection portions respectively disposed at the openings, the vibration absorbing elements are pivotally disposed in the pivotal connection portions respectively, and at least a part of each of the vibration absorbing elements protrudes inwardly from the surface so that the distance between opposing vibration absorbing elements is smaller than the distance between the two lateral walls.

3. The vibration-absorbing module as claimed in claim 2, wherein each of the pivotal connection portions comprises a first pivotal connection hole and a second pivotal connection hole disposed at two opposite sides of the opening, the second pivotal connection hole is further away from the bottom plate than the first pivotal connection hole, each of the vibration absorbing elements comprises a pivot and a vibration absorbing body, the pivot penetrates through the vibration absorbing body, and two opposite ends of the pivot are pivotally disposed in the first pivotal connection hole and the second pivotal connection hole respectively.

4. The vibration-absorbing module as claimed in claim 3, wherein each of the pivotal connection portions has channel communicating with the first pivotal connection hole.

5. The vibration-absorbing module as claimed in claim 1, wherein the electronic device is a hard disk.

6. A case structure configured for accommodating an electronic device, the case structure comprising:
a bottom plate;
two lateral walls disposed in parallel with each other a distance from each other; and
a plurality of pairs of opposing vibration absorbing elements pivotally disposed on the two lateral walls, wherein a distance between the opposing vibration absorbing elements is smaller than the distance between the two lateral walls, the vibration absorbing elements being configured to contact two opposite sides of the electronic device.

7. The case structure as claimed in claim 6, wherein each of the lateral walls has a surface and a plurality of openings penetrating through the surface, each of the lateral walls provides a plurality of pivotal connection portions respectively disposed at the openings, the vibration absorbing elements are pivotally disposed in the pivotal connection portions respectively, and at least a part of each of the vibration absorbing elements protrudes inwardly from the surface so that the distance between opposing vibration absorbing elements is smaller than the distance between the two lateral walls.

8. The case structure as claimed in claim 7, wherein each of the pivotal connection portions comprises a first pivotal connection hole and a second pivotal connection hole disposed at two opposite sides of the opening, the second pivotal connection hole is further away from the bottom plate than the first pivotal connection hole, each of the vibration absorbing elements comprises a pivot and a vibration absorbing body, the pivot penetrates through the vibration absorbing body, and two opposite ends of the pivot are pivotally disposed in the first pivotal connection hole and the second pivotal connection hole respectively.

9. The case structure as claimed in claim 8, wherein each of the pivotal connection portions has a channel communicating with the first pivotal connection hole.

10. The case structure as claimed in claim 6, wherein the electronic device is a hard disk.

11. A case for mounting a hard drive, the case comprising:
a bottom plate;
vertical walls perpendicular to the bottom plate;
a plurality of vibration-absorbing wheels pivotally mounted in the vertical walls, each vibration-attenuating wheel having an axis of rotation perpendicular to the bottom plate.

12. The case according to claim 11, wherein each vibration-absorbing wheel comprises a vibration absorbing body mounted on an axial pivot member that extends all the way through, and extends upwardly and downwardly from, the wheel.

13. The case according to claim 12, wherein wheel mounting openings are formed in the vertical walls for pivotally mounting the vibration-absorbing wheels.

14. The case according to claim 13, wherein the vertical walls are formed with tabs that extend upwardly and downwardly in each of the wheel mounting openings and bend perpendicularly from the wall.

15. The case according to claim 14, wherein a hole is formed in each of the tabs for receiving an axial pivot member of a wheel and enabling the axial pivot member to pivot relative thereto.

16. The case according to claim 15, wherein channels are formed in some of the tabs to enable an axial pivot member to be snapped into a hole connected to the channel.

17. The case according to claim 16, wherein a portion of each wheel protrudes inwardly from the vertical wall in which it is mounted.

18. The case according to claim 17, wherein at least an exterior portion of each of the vibration-absorbing wheels is made of flexible material.

19. The case according to claim 18, wherein the vibration-absorbing wheels are cylindrical in shape.

20. The case according to claim 18, wherein the vibration-absorbing wheels are spherical in shape.
